(19) United States
(12) Patent Application Publication
(10) Pub. No.: US 2020/0270480 A1
(43) Pub. Date: Aug. 27, 2020

(54) ONE PART THERMAL-CURING ACRYLATE ADHESIVE PRECURSOR AND PREPARATION METHOD THEREOF

(71) Applicant: 3M INNOVATIVE PROPERTIES COMPANY, St. Paul, MN (US)

(72) Inventor: Lingjie Tong, Shanghai (CN)

(21) Appl. No.: 16/629,697

(22) PCT Filed: Jul. 6, 2018
(86) PCT No.: PCT/IB2018/055017

§ 371 Date: Jan. 9, 2020

(30) Foreign Application Priority Data
Jul. 13, 2017 (CN) 201710572638.6

(51) Int. Cl. C09J 4/00; C08F 220/18

(52) U.S. Cl. CPC C09J 4/00; C08F 220/1811

(57) ABSTRACT

The present invention provides a one-part thermal-curing acrylate adhesive precursor, calculated by 100 wt. % of said one-part thermal-curing acrylate adhesive precursor, comprising: 20 to 85 wt. % of polyurethane modified acrylate oligomer; 5 to 25 wt. % of methacrylic acid; 5 to 65 wt. % of acrylate monomer; 0.5 to 5 wt. % of adhesion promoter; and 1 to 12 wt. % of initiator. The present invention also provides a preparation method for said one-part thermal-curing acrylate adhesive precursor. According to the technical scheme of the present invention, a one-part acrylate adhesive precursor with excellent adhesive properties, which can be thermal-cured, is provided.

### TECHNICAL FIELD

The present invention relates the field of structural adhesive precursor, in particular, to a one-part thermal-curing acrylate adhesive precursor and preparation method thereof.

### BACKGROUND

Currently, the acrylate structural adhesive precursors sold in the market are mainly two-part acrylate adhesive precursor. When the two-part acrylate adhesive precursor is used, Component A and Component B need to be mixed in advance, which has limited its application in the high-speed adhesive applying process. Although there are static mixing pipes available in the market to help mixing the A, B two-part adhesive in advance, problems such as insufficient mixing may occur, and it becomes more obvious in processes which require micro-application of adhesives. The use of a one-part adhesive can well solve the problem of A, B two-part adhesive with respect to insufficient mixing. The majority of the currently adopted one-part acrylate adhesives contain organic solvent, and the organic solvent may cause problems such as environmental pollutions. In addition, one-part acrylate adhesives also include UV-curable one-part acrylate adhesive precursor, which require additional irradiation processing for the curing and thus the process is complex.

Therefore, a one-part structural adhesive precursor with excellent adhesive properties, after being thermally cured, is urgently needed in the field.

### SUMMARY

In light of the above described technical problems, the purpose of the present invention is to provide a one-part thermal-curing acrylate adhesive precursor with good adhesive properties after curing, which does not contain a solvent, and can be cured with a simple heating process when in use.

The inventor achieved the present invention through extensive and in-depth researches.

According to one aspect of the present invention, a one-part thermal-curing acrylate adhesive precursor is provided, calculated by 100 wt. % of said one-part thermal-curing acrylate adhesive precursor, comprising:

20 to 85 wt. % of polyurethane modified acrylate oligomer;

5 to 25 wt. % of methacrylic acid;

5 to 65 wt. % of acrylate monomer;

0.5 to 5 wt. % of adhesion promoter; and

1 to 12 wt. % of initiator.

According to another aspect of the present invention, a method for preparing a one-part thermal-curing acrylate adhesive precursor is provided, comprising: mixing 20 to 85 wt. % of polyurethane modified acrylate oligomer, 5 to 25 wt. % of methacrylic acid, 5 to 65 wt. % of acrylate monomer, 0.5 to 5 wt. % of adhesion promoter and 1 to 12 wt. % of initiator, calculated by 100 wt. % of said one-part thermal-curing acrylate adhesive precursor.

When compared with the prior art, the advantage of the present invention lies in that: the one-part thermal-curing acrylate adhesive precursor provided by the present invention does not contain a solvent, which is a one-part acrylate adhesive precursor and can be cured through simple heating, featuring a simple process.

### DESCRIPTION OF EMBODIMENTS

The present invention is further described in combination with specific embodiments below. It should be appreciated that, in consideration of other embodiments, if they do not depart from the scope or spirit of the present invention, these can also be implemented. Therefore, the below detailed description is by no means restrictive.

All figures for denoting characteristic dimensions, quantities and physicochemical properties used in this specification and claims are to be understood as modified by a term “about” in all situations, unless indicated otherwise. Therefore, unless otherwise stated, numerical parameters listed in the description and the attached claims are approximate values, and one skilled in the art could properly change the approximate values according to desired properties to be realized using the teaching disclosed herein. The use of numerical ranges represented by end points includes all figures within that range as well as any range within that range. For example, “1 to 5” includes 1, 1.1, 1.3, 1.5, 2, 2.75, 3, 3.80, 4 and 5, etc.

The present invention provides a one-part thermal-curing acrylate adhesive precursor, calculated by 100 wt. % of said one-part thermal-curing acrylate adhesive precursor, comprising:

20 to 85 wt. % of polyurethane modified acrylate oligomer;

5 to 25 wt. % of methacrylic acid;

5 to 65 wt. % of acrylate monomer;

0.5 to 5 wt. % of adhesion promoter; and

1 to 12 wt. % of initiator.

According to some embodiments of the present invention, the formulation of said one-part thermal-curing acrylate structural adhesive precursor may contain a solvent or may not contain a solvent. The solvent which may be contained in the one-part thermal-curing acrylate structural adhesive precursor according to the present invention can be an organic solvent or water. The examples of said organic solvent include one or more selected from the group consisting of ethyl acetate, ethanol, iso-propyl alcohol, methylbenzene etc. When the one-part thermal-curing acrylate adhesive precursor according to the present invention contains a solvent, calculated by 100 wt. % of said one-part thermal-curing acrylate structural adhesive precursor, the amount of said solvent is 5 to 80 wt. %, and preferably 10 to 30 wt. %. In consideration of preventing environmental pollutions, preferably, said one-part thermal-curing acrylate structural adhesive precursor does not contain a solvent.

The polyurethane modified acrylate oligomer according to the above technical scheme of the present invention is one of the basic components constituting said structural adhesive precursor. When said adhesive is in polymerized, said polyurethane modified acrylate oligomer can copolymerize during free radical polymerization reaction with said methacrylic acid and acrylate monomers under the action of the initiator, so as to generate a cured structural adhesive, thereby realizing its adhesive function. The said polyurethane modified acrylate oligomer is a structure obtained through a portion of groups in the acrylate oligomer being modified by polyurethane which is an acrylate polymer that contains urethane segments in the acrylate main polymer backbone. According to some embodiments of the present invention, calculated by 100 wt. % of said one-part thermal-curing acrylate structural adhesive precursor, the amount of said polyurethane modified acrylate oligomer is 20 to 85 wt. %, and preferably 40 to 60 wt. %. The number-average molecular weight of said polyurethane modified acrylate oligomer is within the range of 2200 to 3800, and preferably 3000 to 3500. According to some embodiments of the present invention, said polyurethane modified acrylate oligomer is an aliphatic polyurethane acrylate. The polyurethane modified acrylate oligomer which can be used in the embodiments of the present invention is selected from CN996A (an aliphatic polyurethane acrylate, with a number-average molecular weight being 2200), CN8881 (an aliphatic polyurethane acrylate, with a number-average molecular weight being 3200) and CN9001 (an aliphatic polyurethane acrylate, with a number-average molecular weight being 3800) produced by Sartomer (Guangzhou) Chemicals Ltd.

According to some embodiments of the present invention, said one-part thermal-curing acrylate adhesive precursor contains methacrylic acid (MAA) as a necessary component. When said adhesive is polymerized, said polyurethane modified acrylate oligomer can copolymerize during free radical polymerization reaction with said methacrylic acid and acrylate monomers under the action of the initiator, so as to generate a cured structural adhesive, thereby realizing its adhesive function. According to some embodiments of the present invention, calculated by 100 wt. % of said one-part thermal-curing acrylate adhesive precursor, the amount of said methacrylic acid (MAA) is 5 to 25 wt. %, and preferably 8 to 18 wt. %.

According to some embodiments of the present invention, said one-part thermal-curing acrylate adhesive precursor contains acrylate monomers as a necessary component. The said acrylate monomers comprise acrylate monomer and methacrylate monomers. When said acrylate adhesive precursor is polymerized, said acrylate monomers can copolymerize during free radical polymerization reaction with said polyurethane modified acrylate oligomer and methacrylic acid under the action of the initiator, so as to generate a cured adhesive structure, thereby realizing its adhesive function. According to some embodiments of the present invention, calculated by 100 wt. % of said one-part thermal-curing acrylate adhesive precursor, the amount of acrylate monomers is 5 to 65 wt. %, and preferably 15 to 30 wt. %. According to some embodiments of the present invention, said acrylate monomer is one or more selected from the group consisting of tetrahydrofurfuryl methacrylate, isobornyl methacrylate and trimethylolpropane formal acrylate. The acrylate monomer which can be used in the embodiments of the present invention includes SR203 (tetrahydrofurfuryl methacrylate) produced by Sartomer (Guangzhou) Chemicals Ltd., IBOMA (isobornyl methacrylate) produced by Sartomer (Guangzhou) Chemicals Ltd. and SR531 (trimethylolpropane formal acrylate) produced by Sartomer (Guangzhou) Chemicals Ltd.

According to some embodiments of the present invention, said one-part thermal-curing acrylate adhesive precursor contains an adhesion promoter as a necessary component. There is no special restriction with respect to the particular type of the adhesion promoter, as long as it can promote the adhesion of said structure adhesive to the base. According to some embodiments of the present invention, calculated by 100 wt. % of said one-part thermal-curing acrylate adhesive precursor, the amount of adhesion promoter is 0.5 to 5 wt. %, and preferably 1 to 3 wt. %. According to some embodiments of the present invention, said adhesion promoter is one or more selected from the group consisting of acrylate phosphate and derivatives thereof, methacrylate phosphate and derivatives thereof, ethylene glycol methacrylate phosphate and alkyl acrylate phosphate. The adhesion promoter which can be used in the embodiments of the present invention includes: P-1M produced by Kyoeisha Chemical; JPA-514 produced by Johoku Chemical; P-2M produced by Kyoeisha Chemical; Sipomer PAM-100 produced by Rhodia; Sipomer PAM-200 produced by Rhodia; PM1000 produced by Guangzhou Kinde Chemical Materials Co., Ltd.; PM1500 produced by Guangzhou Kinde Chemical Materials Co., Ltd.; PM1510 produced by Guangzhou Kinde Chemical Materials Co., Ltd.; PM1520 produced by Guangzhou Kinde Chemical Materials Co., Ltd.; PM1570 produced by Guangzhou Kinde Chemical Materials Co., Ltd.; PM1580 and so on produced by Guangzhou Kinde Chemical Materials Co., Ltd. Wherein, P-1M, PAM-100 and PM1000 are 2-Methacryloyloxyethyl phosphate; PM1500, P-2M, JPA-514 and PAM-200 are 2-Hydroxyethyl methacrylate phosphate; and PM1510, PM1520, PM1570 and PM1580 are Alkyl acrylate phosphate.

According to some embodiments of the present invention, said one-part thermal-curing acrylate adhesive precursor contains an initiator as a necessary component.

The function of the initiator is to initiate the free radical polymerization of the polyurethane modified acrylate oligomer, methacrylic acid and acrylate monomers. The said initiator is preferably a thermal initiator. According to some embodiments of the present invention, calculated by 100 wt. % of said one-part thermal-curing acrylate adhesive precursor, the amount of the initiator is 1 to 12 wt. %, and preferably 3 to 9 wt. %. According to some embodiments of the present invention, said thermal initiator is one or more selected from the group consisting of benzoyl peroxide and isopropylbenzene hydroperoxide. The example of the product for benzoyl peroxide is B-55 produced by United Initiators.

The present invention also provides a method for preparing a one-part thermal-curing acrylate adhesive precursor, comprising: mixing 20 to 85 wt. % of polyurethane modified acrylate oligomer, 5 to 25 wt. % of methacrylic acid, 5 to 65 wt. % of acrylate monomer, 0.5 to 5 wt. % of adhesion promoter and 1 to 12 wt. % of initiator, calculated by 100 wt. % of said one-part thermal-curing acrylate adhesive precursor.

According to the technical scheme of the present invention, the polyurethane modified acrylate oligomer, methacrylic acid, acrylate monomer, adhesion promoter and initiator can be manually or mechanically mixed to provide a uniform mixture. However, in order not to affect the storage stability of the obtained adhesive, the mixing is carried out below 30° C., and preferably below 25° C.

According to some embodiments of the present invention, solvent may be added or may not be added in the process of preparing said one-part thermal-curing acrylate adhesive precursor. The solvent which can be added may be an organic solvent or water. The examples of said organic solvent include one or more selected from the group consisting of ethyl acetate, ethanol, iso-propyl alcohol, methylbenzene etc. When the one-part thermal-curing acrylate adhesive precursor according to the present invention contains a solvent, calculated by 100 wt. % of said one-part thermal-curing acrylate adhesive precursor, the amount of said solvent is 5 to 80 wt. %, and preferably 10 to 30 wt. %. In consideration of preventing environmental pollutions, preferably, said one-part thermal-curing acrylate adhesive precursor does not contain a solvent.

The polyurethane modified acrylate oligomer according to the above technical scheme of the present invention is one of the basic components constituting said structure adhesive. When said adhesive is in use, said polyurethane modified acrylate oligomer can carry out free radical polymerization reaction with said methacrylic acid and acrylate monomers under the action of the initiator, so as to generate a cured adhesive structure, thereby realizing its adhesive function. The said polyurethane modified acrylate oligomer is a structure obtained through a portion of groups in the acrylate oligomer being modified by polyurethane. According to some embodiments of the present invention, calculated by 100 wt. % of said one-part thermal-curing acrylate adhesive precursor, the amount of said polyurethane modified acrylate oligomer is 20 to 85 wt. %, and preferably 40 to 60 wt. %. The number-average molecular weight of said polyurethane modified acrylate oligomer is within the range of 2200 to 3800, and preferably 3000 to 3500. According to some embodiments of the present invention, said polyurethane modified acrylate oligomer is an aliphatic polyurethane acrylate. The polyurethane modified acrylate oligomer which can be used in the embodiments of the present invention is selected from CN996A (an aliphatic polyurethane acrylate, with a number-average molecular weight being 2200), CN8881 (an aliphatic polyurethane acrylate, with a number-average molecular weight being 3200) and CN9001 (an aliphatic polyurethane acrylate, with a number-average molecular weight being 3800) produced by Sartomer (Guangzhou) Chemicals Ltd.

According to some embodiments of the present invention, said one-part thermal-curing acrylate adhesive precursor contains methacrylic acid (MAA) as a necessary component. When said adhesive is in use, said polyurethane modified acrylate oligomer can carry out free radical polymerization reaction with said methacrylic acid and acrylate monomers under the action of the initiator, so as to generate a cured adhesive structure, thereby realizing its adhesive function. According to some embodiments of the present invention, calculated by 100 wt. % of said one-part thermal-curing acrylate adhesive precursor, the amount of said methacrylic acid (MAA) is 5 to 25 wt. %, and preferably 8 to 18 wt. %.

According to some embodiments of the present invention, said one-part thermal-curing acrylate adhesive precursor contains acrylate monomers as a necessary component. The said acrylate monomers comprise acrylate monomer and methacrylate monomers. When said adhesive is in use, said acrylate monomers can carry out free radical polymerization reaction with said polyurethane modified acrylate oligomer and methacrylic acid under the action of the initiator, so as to generate a cured adhesive structure, thereby realizing its adhesive function. According to some embodiments of the present invention, calculated by 100 wt. % of said one-part thermal-curing acrylate adhesive precursor, the amount of acrylate monomers is 5 to 65 wt. %, and preferably 15 to 30 wt. %. According to some embodiments of the present invention, said acrylate monomer is one or more selected from the group consisting of tetrahydrofurfuryl methacrylate, isobornyl methacrylate and trimethylolpropane formal acrylate. The acrylate monomer which can be used in the embodiments of the present invention includes SR203 (tetrahydrofurfuryl methacrylate) produced by Sartomer (Guangzhou) Chemicals Ltd., IBOMA (isobornyl methacrylate) produced by Sartomer (Guangzhou) Chemicals Ltd. and SR531 (trimethylolpropane formal acrylate) produced by Sartomer (Guangzhou) Chemicals Ltd.

According to some embodiments of the present invention, said one-part thermal-curing acrylate adhesive precursor contains an adhesion promoter as a necessary component. There is no special restriction with respect to the particular type of the adhesion promoter, as long as it can promote the adhesion of said structure adhesive to the base. According to some embodiments of the present invention, calculated by 100 wt. % of said one-part thermal-curing acrylate adhesive precursor, the amount of adhesion promoter is 0.5 to 5 wt. %, and preferably 1 to 3 wt. %. According to some embodiments of the present invention, said adhesion promoter is one or more selected from the group consisting of acrylate phosphate and derivatives thereof, methacrylate phosphate and derivatives thereof, ethylene glycol methacrylate phosphate and alkyl acrylate phosphate. The adhesion promoter which can be used in the embodiments of the present invention includes: P-1M produced by Kyoeisha Chemical; JPA-514 produced by Johoku Chemical; P-2M produced by Kyoeisha Chemical; Sipomer PAM-100 produced by Rhodia; Sipomer PAM-200 produced by Rhodia; PM1000 produced by Guangzhou Kinde Chemical Materials Co., Ltd.; PM1500 produced by Guangzhou Kinde Chemical Materials Co., Ltd.; PM1510 produced by Guangzhou Kinde Chemical Materials Co., Ltd.; PM1520 produced by Guangzhou Kinde Chemical Materials Co., Ltd.; PM1570 produced by Guangzhou Kinde Chemical Materials Co., Ltd.; PM1580 and so on produced by Guangzhou Kinde Chemical Materials Co., Ltd. Wherein, P-1M, PAM-100 and PM1000 are 2-Methacryloyloxyethyl phosphate. PM1500, P-2M, JPA-514 and PAM-200 are 2-Hydroxyethyl methacrylate phosphate. PM1510, PM1520, PM1570 and PM1580 are Alkyl acrylate phosphate.

According to some embodiments of the present invention, said one-part thermal-curing acrylate adhesive precursor contains an initiator as a necessary component. The function of the initiator is to initiate the free radical polymerization of the polyurethane modified acrylate oligomer, methacrylic acid and acrylate monomers. The said initiator is preferably a thermal initiator. According to some embodiments of the present invention, calculated by 100 wt. % of said one-part thermal-curing acrylate adhesive precursor, the amount of the initiator is 1 to 12 wt. %, and preferably 3 to 9 wt. %. According to some embodiments of the present invention, said thermal initiator is one or more selected from the group consisting of benzoyl peroxide and isopropylbenzene hydroperoxide. The example of the product for benzoyl peroxide is B-55 produced by United Initiators.

The present invention is described in more details in combination with examples below. It should be pointed out that, these descriptions and examples are to facilitate a better understanding of the present invention, which shall not be construed as to limit the present invention. The protection scope of the present invention shall be in accordance with the appended Claims.

### EXAMPLES

In the present invention, unless otherwise pointed out, all reagents adopted are commercially purchased products which were directly used without further purification treatment. In addition, the “%” mentioned is “wt. %”, and the “parts” mentioned is “parts by weight”.

### Test Method

According to the below methods, various structure adhesives obtained in the below examples are tested with respect to the shear strength properties, so as to evaluate the adhesion properties thereof.

Two aluminum plates measuring 101.6 mm (length)×25.4 mm (width)×4 mm (height) were used, and the surfaces were cleaned with IPA (isopropyl alcohol) and dried 30 minutes by air at room temperature. The two aluminum plates are overlapped in such a way that 25.4 mm (width)×12.7 mm (length) from one end of each plate were overlapped, wherein the structure adhesive prepared in the example, with a use amount of 0.1 g, is clamped and evenly distributed between the overlapping areas of the two aluminum plates, and then these two aluminum plates were thermal cured 30 minutes in oven at 120° C.

In accordance with dynamic shear testing standard-ASTM D1002-72, and using an Instron Model 5969 Tensile Tester, available from Instron, Norwood, Mass., USA, the shear strength was tested under room temperature (22-24° C.) and at a tensile speed of 2.54 mm/min. According to relevant regulations in the field, when the tested shear strength is greater than 7 MPa, the practical application requirement for the adhesive can be met.

### Example 1

According to the formulation as shown in below Table 1, 5 g of SR203 (tetrahydrofurfuryl methacrylate), 85 g of CN996A ((an aliphatic polyurethane acrylate, with a number-average molecular weight being 2200), 5 g of methacrylic acid (MAA), 2 g of the mixture of P-1 (2-methacryloyloxyethyl phosphate) and P-2 (wherein, the weight ratio of P-1 to P-2 is 1:2) and 3 g of B-55 (benzoyl peroxide) were mechanically mixed in a mixer at a temperature below 30° C. and a rotation speed of 200 revolutions per minute (rpm), for 30 minutes.

### Example 2-12

The compositions of Examples 2-12, as shown in Table 1, were prepared as described for Example 1.

According to the test method for the evaluation of shear strength properties as described above, testing was carried out with respect to the various structure adhesives obtained from the above Examples 1-12, and the detailed results are shown in below Table 1.

TABLE 1

| Raw Material | Example | Example | Example | Example | Example | Example |
|---|---|---|---|---|---|---|
| Code | 1 | 2 | 3 | 4 | 5 | 6 |
| SR203 | 5.00% | 15.63% | | 16.13% | 16.67% | |
| IBOMA | | | 15.63% | | | |
| SR531 | | | | | | 16.67% |
| CN996A | 85.00% | 54.68% | 54.68% | 56.45% | 58.33% | 58.33% |
| CN8881 | | | | | | |
| CN9001 | | | | | | |
| MAA | 5.00% | 17.19% | 17.19% | 17.74% | 18.34% | 18.34% |
| P-1/P-2 | 2.00% | 3.13% | 3.13% | 3.23% | 3.33% | 3.33% |
| B-55 | 3.00% | 9.37% | 9.37% | 6.45% | 3.33% | 3.33% |
| Bonding Strength | 13.8 | 18.6 | 8.9 | 25.5 | 24.2 | 19.3 |
| (Mpa) | | | | | | |
| Raw Material | Example | Example | Example | Example | Example | Example |
| Code | 7 | 8 | 9 | 10 | 11 | 12 |
| SR203 | 30.00% | 65.00% | 5.00% | 10.00% | 10.00% | 12.00% |
| IBOMA | | | 5.00% | | | 5.00% |
| SR531 | | | 5.00% | | | 6.00% |
| CN996A | 43.50% | 20.00% | 58.00% | | | 20.00% |
| CN8881 | | | | | 80.00% | 20.00% |
| CN9001 | | | | 80.00% | | 20.00% |
| MAA | 25.00% | 5.00% | 10.00% | 5.00% | 5.00% | 10.00% |
| P-1/P-2 | 0.50% | 5.00% | 5.00% | 2.00% | 2.00% | 2.00% |
| B-55 | 1.00% | 5.00% | 12.00% | 3.00% | 3.00% | 5.00% |
| Bonding Strength | 25.4 | 20.3 | 16.3 | 17.3 | 17.6 | 17.8 |
| (Mpa) | | | | | | |

It is clear from the above Example 1-12, through the method according to the present invention, a one-part acrylate adhesive precursor with good adhesive properties, which can be thermal-cured, can be prepared.

The examples described in the present invention are merely descriptions of the preferred implementation methods of the present invention, and are not to limit the conception and scope of the present invention. The various modifications and improvements made by a person skilled in the art with respect to the technical schemes of the present invention shall all fall into the protection scope of the present invention, and the technical contents of the present invention requested to be protected have all been stated in the Claims.

What is claimed is:

1. A one-part thermal-curing acrylate adhesive precursor, calculated by 100 wt. % of said one-part thermal-curing acrylate adhesive precursor, comprising:
20 to 85 wt. % of polyurethane modified acrylate oligomer;
5 to 25 wt. % of methacrylic acid;
5 to 65 wt. % of acrylate monomer;
0.5 to 5 wt. % of adhesion promoter; and
1 to 12 wt. % of initiator.

2. The one-part thermal-curing acrylate adhesive precursor according to claim 1, wherein said one-part thermal-curing acrylate adhesive precursor does not contain a solvent.

3. The one-part thermal-curing acrylate adhesive precursor according to claim 1, wherein the number-average molecular weight of said polyurethane modified acrylate oligomer is within the range of 2200 to 3800 grams/mole.

4. The one-part thermal-curing acrylate adhesive precursor according to claim 1, wherein said polyurethane modified acrylate oligomer is an aliphatic polyurethane acrylate.

5. The one-part thermal-curing acrylate adhesive precursor according to claim 1, wherein said acrylate monomer is one or more selected from the group consisting of tetrahydrofurfuryl methacrylate, isobornyl methacrylate and trimethylolpropane formal acrylate.

6. The one-part thermal-curing acrylate adhesive precursor according to claim 1, wherein said adhesion promoter is one or more selected from the group consisting of acrylate phosphate and derivatives thereof, methacrylate phosphate and derivatives thereof, ethylene glycol methacrylate phosphate and alkyl acrylate phosphate.

7. The one-part thermal-curing acrylate adhesive precursor according to claim 1, wherein said initiator is a thermal initiator.

8. The one-part thermal-curing acrylate adhesive precursor according to claim 7, wherein said thermal initiator is one or more selected from the group consisting of benzoyl peroxide and isopropylbenzene hydroperoxide.

9. A method for preparing a one-part thermal-curing acrylate adhesive precursor, comprising: mixing 20 to 85 wt. % of polyurethane modified acrylate oligomer, 5 to 25 wt. % of methacrylic acid, 5 to 65 wt. % of acrylate monomer, 0.5 to 5 wt. % of adhesion promoter and 1 to 12 wt. % of initiator, calculated by 100 wt. % of said one-part thermal-curing acrylate adhesive precursor.

10. The method according to claim 9, wherein the mixing is carried out at a temperature below 30° C.

11. The method according to claim 9, wherein during the mixing process no solvent is added.

12. The method according to claim 9, wherein the number-average molecular weight of said polyurethane modified acrylate oligomer is within the range of 2200 to 3800 grams/mole.

13. The method according to claim 9, wherein said polyurethane modified acrylate oligomer is an aliphatic polyurethane acrylate.

14. The method according to claim 9, wherein said acrylate monomer is one or more selected from the group consisting of tetrahydrofurfuryl methacrylate, isobornyl methacrylate and trimethylolpropane formal acrylate.

15. The method according to claim 9, wherein said adhesion promoter is one or more selected from the group consisting of acrylate phosphate and derivatives thereof, methacrylate phosphate and derivatives thereof, ethylene glycol methacrylate phosphate and alkyl acrylate phosphate.

16. The method according to claim 9, wherein said initiator is a thermal initiator.

17. The method according to claim 9, wherein said thermal initiator is one or more selected from the group consisting of benzoyl peroxide and isopropylbenzene hydroperoxide.
